(19) United States
(12) Patent Application Publication
(10) Pub. No.: US 2008/0252935 A1
(43) Pub. Date: Oct. 16, 2008

(54) PRINTING APPARATUS AND DATA UPDATE PROCESSING METHOD

(75) Inventor: Makiko MAEDA, Kawasaki-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 11/926,765

(22) Filed: Oct. 29, 2007

(30) Foreign Application Priority Data
Oct. 31, 2006 (JP) 2006-296596

(51) Int. Cl. H04N 1/00

(52) U.S. Cl. 358/403

(57) ABSTRACT

Data registered in a server can be updated without any particular need to look up the storage destination of data to be updated. A printing apparatus displays on a display a layout of a plurality of data read from the server, selects an area by an operation on the displayed data, and designates, as data to be updated, data corresponding to the selected area. The printing apparatus inputs image data by scanning an image and saves the image data at the storage destination of the data to be updated in the server in place of the data to be updated.

### BACKGROUND OF THE INVENTION

1. Field of the Invention

The present invention relates to an update processing technique for updating data stored in a data recording apparatus.

2. Description of the Related Art

Conventionally, a digital multi-function peripheral (MFP) can create print document data such as form data by acquiring image data together with text data registered in a server and merging these data. The digital multi-function peripheral can also scan image data, and send the scanned image data by e-mail to a destination designated by a user.

However, even if the user tries to change part of created form data from the digital multi-function peripheral, he cannot update image data of a specific ID in a specific table in a specific database from the digital multi-function peripheral. Because of this a user must access the database from a PC and update the image data directly; in order to do so, however the user must first look up what table the image data to be updated is stored in, as well as its corresponding ID.

If the user uses scanned image data or input text data to change a portion of the form data in a specific digital multi-function peripheral without updating data in the server, this change will not be reflected in other digital multi-function peripherals, and user must customize form data in each digital multi-function peripheral. This is inconvenient when a plurality of digital multi-function peripherals are always used to generate the same form data.

To solve this, for example, Japanese Patent Laid-Open No. 2005-73194 discloses a data transfer system which scans an identification card representing the identity of a user, and transfers the scanned image data to a terminal device in which the identity information is registered. According to this reference, scanned image data can be easily transmitted to another digital multi-function peripheral.

However, in the case of Japanese Patent Laid-Open No. 2005-73194, because the invention has a constitution of identification information being read from an identification card and transferred to a terminal device corresponding to the identification information, data which has been made to correspond to identification information and registered in advance can only be utilized in the case that the identification information is updated using image data including the identification information. For this reason, there is a problem that the user cannot freely select data to be updated and update using scanned optional image data.

### SUMMARY OF THE INVENTION

It is an object of the present invention to allow update of data registered in a server using a scanned image in each multi function peripheral without any particular lookup of its storage destination by a user.

The present invention is a printing apparatus which prints by reading a plurality of data from a server and composing the plurality of data, the apparatus comprising:
a display unit configured to display a layout of the plurality of data read from the server;
a selection unit configured to select a data area in the layout;
an image input unit configured to input image data by scanning an image; and
a save unit configured to save the image data input by the image input unit in the server in correspondence with the area selected in the layout.

According to the present invention, data selected by layout and display operations is designated as data to be updated. A scanned image is stored at the storage destination of the data to be updated in a data recording apparatus. The present invention can update data recorded in the data recording apparatus to a scanned image without any particular lookup of the storage destination of data to be updated.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the overall arrangement of a printing apparatus according to an embodiment of the present invention;

FIG. 2 is a block diagram showing a module configuration of an application;

FIG. 3 is a view showing an example of a document set stored in the document set DB of the printing apparatus;

FIG. 4 is a view showing a display example of preview image data;

FIG. 5 is a view showing an example of document data generation;

FIG. 6 is a flowchart showing processing by the application of the printing apparatus;

FIGS. 7A and 7B are flowcharts showing processing by the operation request transfer unit of the application;

FIG. 8 is a flowchart showing processing by a document set processor;

FIG. 9 is a flowchart showing processing by an update processor;

FIG. 10 is a flowchart showing processing by an output data generator; and

FIG. 11 is a view showing a system configuration using the printing apparatus.

### DESCRIPTION OF THE EMBODIMENT

A preferred embodiment of the present invention will now be described in detail in accordance with the accompanying drawings.

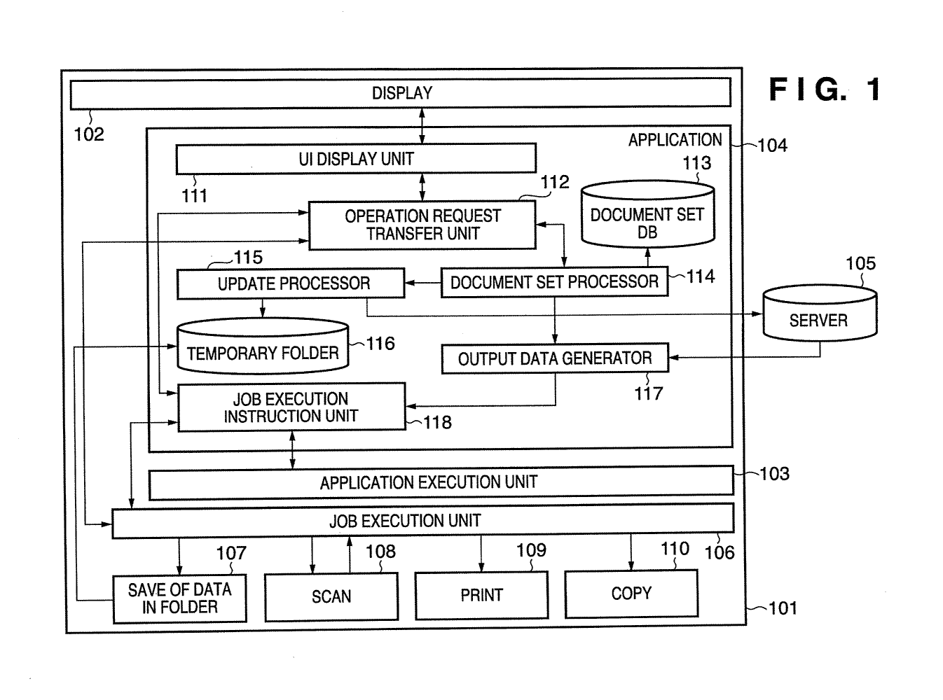

FIG. 1 is a block diagram showing the overall arrangement of a printing apparatus (digital multi-function peripheral (MFP)) according to the embodiment of the present invention. As shown in FIG. 1, a printing apparatus 101 comprises a display 102, application execution unit 103, application 104, and job execution unit 106.

The display 102 displays the user interface (UI) window of the application 104. The application execution unit 103 operates the application 104. The application 104 acquires data from a server (data recording apparatus) 105 to generate document data, or updates the server 105 with data acquired by scanning or text input. In this specification, “update” means transmission processing to update data stored in the server 105. The function of the application 104 will be described in detail below.

The job execution unit 106 receives instructions from the application 104, and executes jobs such as processing 107 to save data in a folder, scan processing 108, print processing 109, and copy processing 110.

In the application 104, a UI display unit 111 displays a UI window for a user operation on the display 102.

An operation request transfer unit 112 requests processes of the UI display unit 111, and a document set processor 114 and job execution instruction unit 118 (to be described later) in accordance with user operations such as selection of a document set, scanning, and text input.

A document set DB (Data Base) 113 stores a document set for generating document data.

The document set processor 114 requests an update processor 115 and output data generator 117 (to be described later) to transfer a document set to the operation request transfer unit 112, update data, and generate document data.

The update processor 115 updates the server 105 with image data acquired by scanning or text data input from the UI display unit 111.

A temporary folder 116 temporarily stores image data acquired by scanning.

The output data generator 117 acquires image data and text data from the server 105, merges them on the basis of a specific layout file, and performs data generation processing for executing a job.

The job execution instruction unit 118 receives job requests for save processing 107, scan processing 108, print processing 109, and copy processing 110 from the operation request transfer unit 112 and output data generator 117. The job execution instruction unit 118 transfers the job requests to the job execution unit 106.

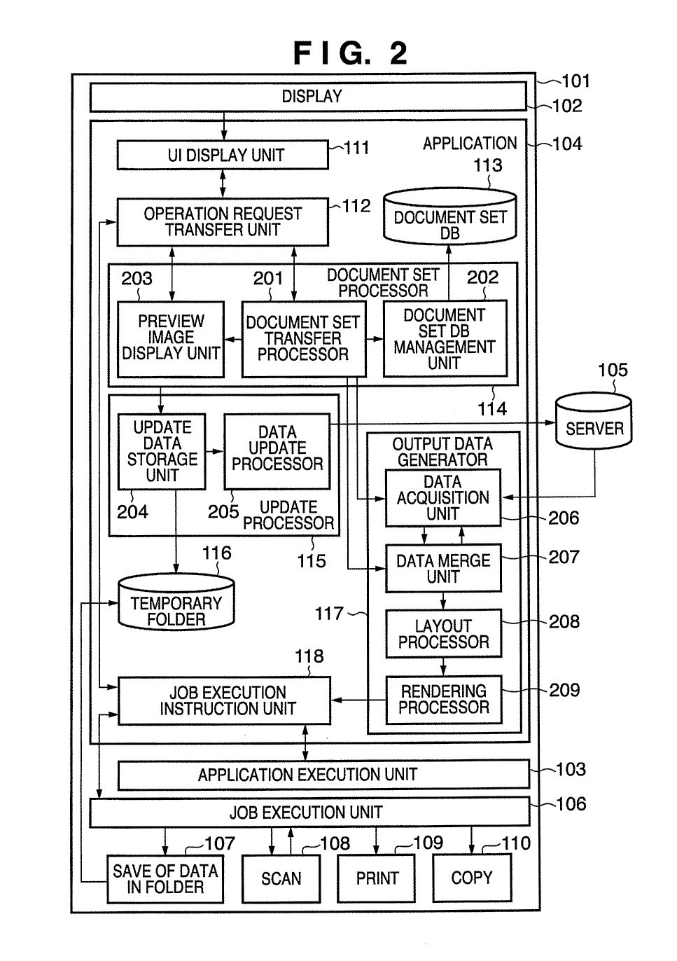

FIG. 2 is a block diagram showing a module configuration of the application 104 according to the embodiment. In the document set processor 114, a document set transfer processor 201 transfers a document set to the operation request transfer unit 112, the output data generator 117, and a preview image display unit 203 (to be described later).

A document set DB management unit 202 acquires a document set from the document set DB 113, or stores a new document set in the document set DB 113.

The preview image display unit 203 transfers preview image data contained in a document set to the operation request transfer unit 112. The preview image display unit 203 transfers information regarding data updated by the user to the update processor 115.

In the update processor 115, an update data storage unit 204 stores image data acquired by scanning in the temporary folder 116. The update data storage unit 204 transfers, to a data update processor 205 (to be described later), information representing the image data stored in the temporary folder 116 and information representing the data storage destination. The update data storage unit 204 transfers, to the data update processor 205, text data input from a text input window.

The data update processor 205 updates the server 105 with data transferred from the update data storage unit 204.

In the output data generator 117, a data acquisition unit 206 acquires data from the server 105.

A data merge unit 207 merges data acquired by the data acquisition unit 206 on the basis of a layout file transferred from the document set transfer processor 201.

A layout processor 208 lays out data merged by the data merge unit 207.

A rendering processor 209 renders generated document data laid out by the layout processor 208, and transfers the rendered data to the job execution instruction unit 118.

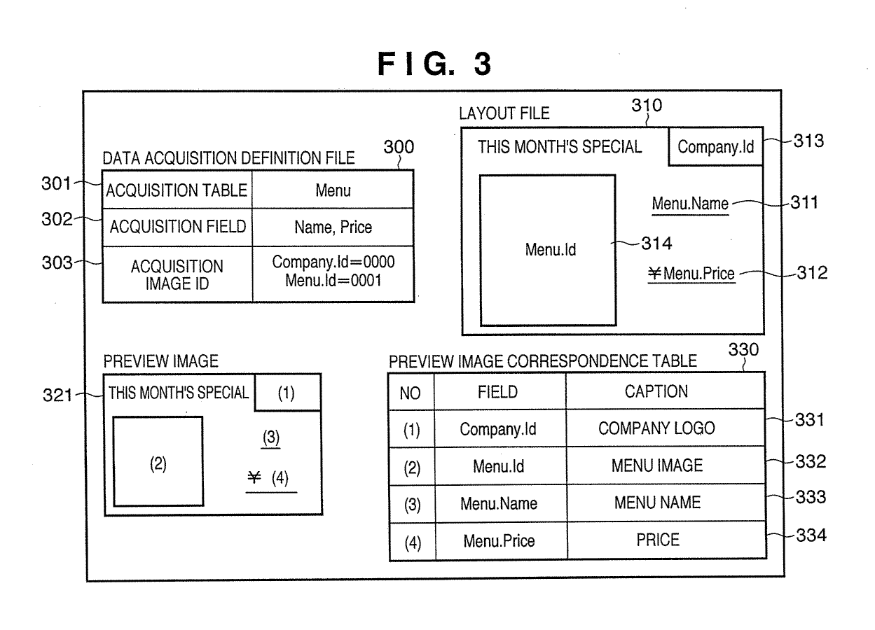

FIG. 3 is a view showing an example of a document set stored in the document set DB 113 of the printing apparatus 101 according to the embodiment.

The document set is made up of a data acquisition definition file 300, layout file 310, preview image data 321, and preview image correspondence table 330.

The data acquisition definition file 300 defines a data acquisition method. The layout file 310 describes data layout information. The preview image data 321 is used to display the layout locations of data to be merged with document data. The preview image correspondence table 330 describes information on data to be merged with preview image data.

The description contents of the data acquisition definition file 300 will now be explained. Reference numeral 301 denotes an acquisition table representing a table to be acquired from the server 105. In this example, “Menu” is defined.

Reference numeral 302 denotes an acquisition field representing a field of the acquisition table 301 in the server 105. This example defines acquisition of data in fields “Name” and “Price”. Reference numeral 303 denotes an acquisition image ID which defines ID information of image data to be acquired.

The description of the layout file will now be explained. “Menu.Name” 311 means that “Name,” described in the acquisition field 302 of the acquisition table 301 “Menu,” is set as a menu name. “Menu.Price” 312 means that “Price” is set as a price, similar to the “Menu.Name” 311.

“Company.Id” 313 means that image data acquired from the server 105 on the basis of information “Company.Id=0000” described in the acquisition image ID 303 is set. “Menu.Id” 314 means that image data acquired from the server 105 on the basis of information “Menu.Id=0001” is pasted, similar to the “Company.Id” 313.

The descriptions of the preview image data 321 and preview image correspondence table 330 will now be explained. The preview image data 321 describes the layout structure of generated document data, and data layout locations (1) to (4).

A description 331 in the preview image correspondence table 330 represents a field corresponding to (1) in the preview image data, and the caption of data in (1). Descriptions 332 to 334 also represent fields corresponding to (2) to (4), and the captions of data in (2) to (4).

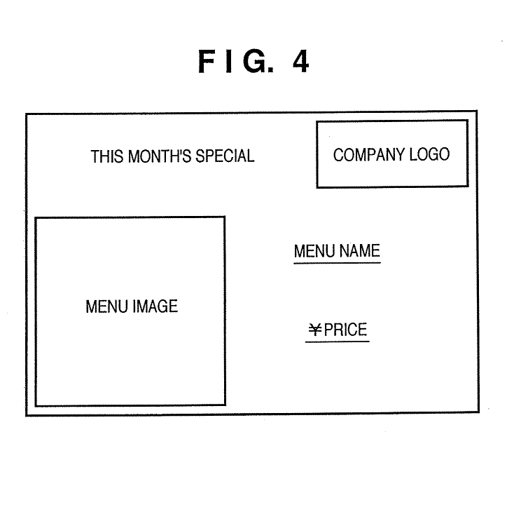

FIG. 4 is a view showing a display example of preview image data. Captions in the preview image correspondence table 330 are set and displayed in fields corresponding to (1), (2), (3), and (4) of the preview image data.

When the user selects image part (2) in the preview image data, the system obtains the field “Menu.Id” corresponding to (2) from the description 332 of the preview image correspondence table. The system refers to the data acquisition definition file 300 for the field “Menu.Id”, and recognizes that “Menu.Id” is an acquisition image ID. The system requires the user to perform a scan, and prompts him to scan image data for a menu to be updated. Further, the system determines that “Menu.Id=0001” described in the acquisition image ID 303 is the update destination of the image data. The system designates the update destination, and updates the image data.

When the user selects (3) and (4) in the preview image data, the system refers to the data acquisition definition file 300, and recognizes that “Menu.Name” and “Menu.Price” represent an acquisition table and acquisition fields which store text data. Thus, the system requests the user to input text data. The system determines that the update destinations of the input text data are the acquisition fields “Name” and “Price” of the acquisition table “Menu”. The system designates the update destinations, and updates the acquisition fields with the respective text data.

In this manner, the system can designate data to be updated in accordance with selection of the data from preview image data.

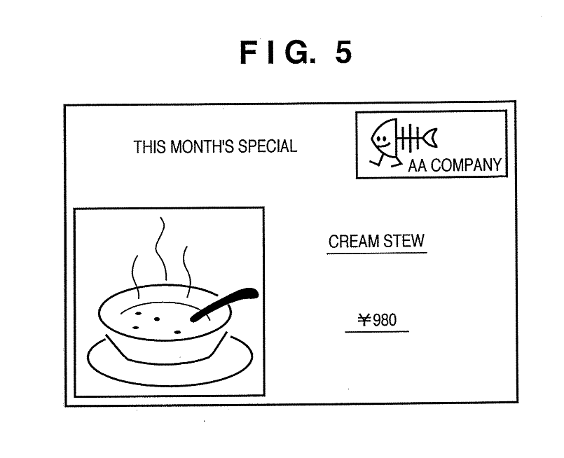

FIG. 5 is a view showing an example of document data generation according to the embodiment. Text data “cream stew” and “980” acquired from the server 105 are set at data layout locations corresponding to “Menu.Name” and “Menu.Price”. Image data acquired from the server 105 are set at data layout locations corresponding to “Company.Id” and “Menu.Id”.

The printing apparatus 101 according to the embodiment has been described using the document set shown in FIG. 3. If there is a data processing apparatus which only generates form data without updating form data, a document set suffices to be made up of only the data acquisition definition file 300 and layout file 310. If a data processing apparatus accessible to the same server as that of a printing apparatus holds the same data acquisition definition file and layout file, it can obtain the same form data as that by the printing apparatus.

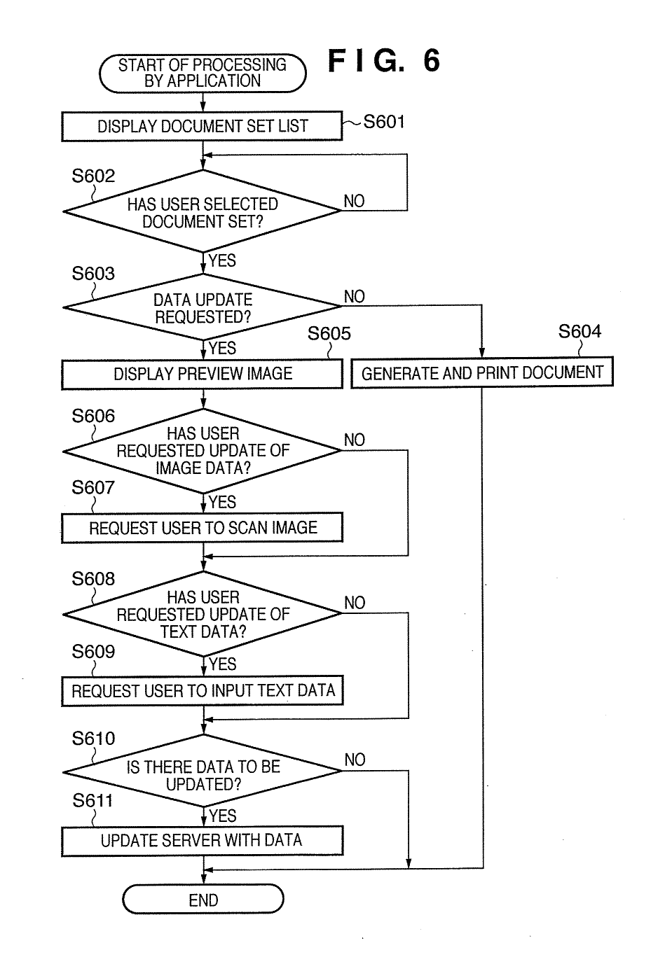

FIG. 6 is a flowchart showing an outline of processing by the application 104 of the printing apparatus 101 according to the embodiment.

The application 104 displays a document set list on the display (S601). The application 104 determines whether the user has selected a document set (S602). If the user has selected a document set (YES in S602), the application 104 inquires of the user whether to update document data. The document set list is data to be used for displaying a list of document sets.

If the user does not request update of document data (NO in S603), the application 104 generates document data on the basis of the selected document set, prints it (S604), and ends the process.

If the user requests update of document data (YES in S603), the application 104 sets information of each corresponding field of the preview image correspondence table at each data layout location of preview image data. The application 104 displays the preview image data on the display 102 (S605).

The application 104 determines whether the user has manually indicated a need for update of the image data for the displayed preview image (S606). If the user requests update of the image data (YES in S606), the application 104 requests, via a UI display of the UI display unit 111, that the user perform a scan (S607).

If the user does not request update of the image data (NO in S606), the application 104 shifts the process to S608 without executing scan request process in S607.

In S608, the application 104 determines whether the user has operated the displayed preview image data to request update of the text data. If the user requests update of the text data (YES in S608), the application 104 requests the user to input text data via a UI display by the UI display unit 111 (S609).

If the user does not request update of the text data (NO in S608), the application 104 shifts the process to S610 without executing text input request process in S609.

In S610, the application 104 determines whether there is data (image data or text data) which has been obtained from the user and is to be updated (S610). That is, the application 104 determines whether image data or text data has been input by a user operation.

If there is data for update (YES in S610), the application 104 transmits the data to the server 105 (S611). At this time, the application 104 refers to a data storage destination (acquisition destination) managed by the data acquisition definition file 300 in FIG. 3. The application 104 designates the storage destination and transmits the data.

If there is no data to be updated (NO in S610), the application 104 ends the process.

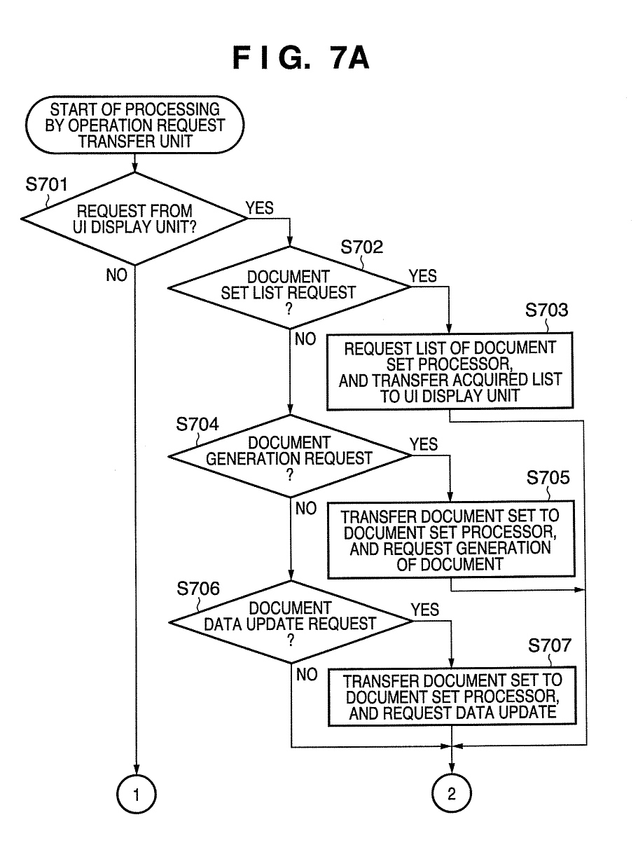

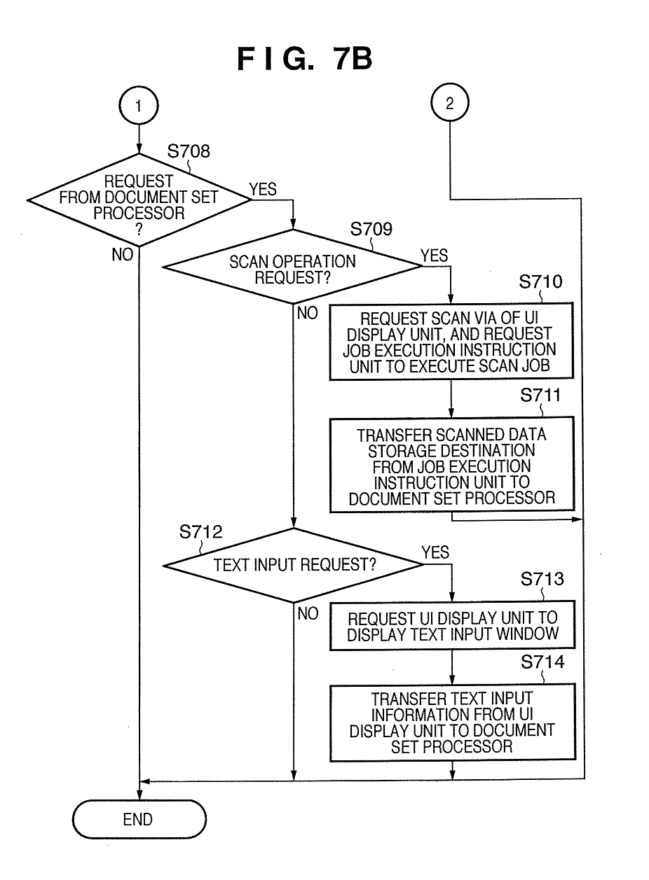

FIGS. 7A and 7B are flowcharts showing processing by the operation request transfer unit 112 of the application 104 according to the embodiment.

The operation request transfer unit 112 determines whether it has accepted a request from the UI display unit 111 (S701). If the operation request transfer unit 112 has accepted a request from the UI display unit 111, the process shifts to S702.

In S702, the operation request transfer unit 112 determines whether the request is a document set list request.

If the request is a document set list request (YES in S702), the operation request transfer unit 112 requests a document set list of the document set processor 114, and transfers the acquired list to the UI display unit 111 (S703).

If the request is not a document set list request (NO in S702), the operation request transfer unit 112 determines whether the request is a document data generation request (S704).

If the request is a document data generation request (YES in S704), the operation request transfer unit 112 transfers a designated document set to the document set processor 114, and requests the document set processor 114 to generate document data (S705).

If the request is not a document data generation request (NO in S704), the operation request transfer unit 112 determines whether the request is a document data update request (S706).

If the request is a document data update request (YES in S706), the operation request transfer unit 112 transfers a designated document set to the document set processor 114, and requests the document set processor 114 to update document data (S707).

If the operation request transfer unit 112 has not accepted a request from the UI display unit 111 (NO in S701), it determines whether it has accepted a request from the document set processor 114 (S708).

If the operation request transfer unit 112 has accepted a request from the document set processor 114 (YES in S708), it determines whether the request is a scan operation request (S709).

If the request is a scan operation request, the operation request transfer unit 112 requests the UI display unit 111 to display a scan operation window, and requests the output data generator 117 to execute a scan job (S710). The operation request transfer unit 112 transfers a scanned image data storage destination from the job execution instruction unit 118 to the document set processor 114 (S711).

If the request is not a scan operation request, the operation request transfer unit 112 determines whether the request from the document set processor 114 is a text data input request (S712).

If the request is a text data input request (YES in S712), the operation request transfer unit 112 requests the UI display unit 111 to display a text data input window (S713). The operation request transfer unit 112 transfers input text data to the document set processor 114 (S714).

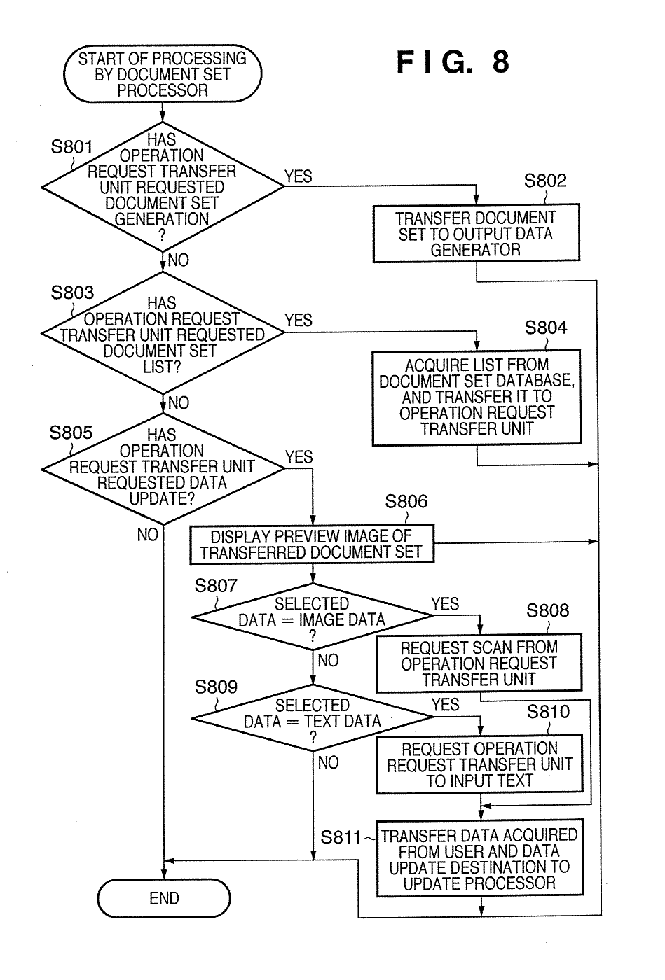

FIG. 8 is a flowchart showing processing by the document set processor 114 according to the embodiment.

The document set processor 114 determines whether the operation request transfer unit 112 has requested generation of document data (S801).

If the operation request transfer unit 112 has requested generation of document data (YES in S801), the document set processor 114 transfers a document set to the output data generator 117.

If the operation request transfer unit 112 has not requested generation of document data (NO in S801), the document set processor 114 determines whether the operation request transfer unit 112 has requested a document set list (S803).

If the operation request transfer unit 112 has requested a document set list (YES in S803), the document set processor 114 acquires a document set list from the document set DB 113, and transfers it to the operation request transfer unit 112 (S804).

If the operation request transfer unit 112 has not requested a document set list, the document set processor 114 determines whether the operation request transfer unit 112 has requested a data update (S805).

If the operation request transfer unit 112 has requested a data update (YES in S805), the document set processor 114 instructs the output data generator 117 to merge information in the preview image correspondence table with preview image data (S806). The preview image data is contained in a document set transferred from the document set processor 114. The output data generator 117 generates preview image data by merging information in the preview image correspondence table. The display 102 displays the generated preview image data under the control of the UI display unit 111.

The document set processor 114 determines whether update data selected by the user on the preview image data is image data (S807).

If the update data selected by the user is image data (YES in S807), the document set processor 114 requests the operation request transfer unit 112 to display a scan operation window (S808). The operation request transfer unit 112 instructs the UI display unit 111 to display the scan operation window. The UI display unit 111 displays the scan operation window on the display 102. Then, the process shifts to S811.

If the update data selected by the user is not image data (NO in S807), the document set processor 114 determines whether the update data selected by the user on the preview image data is text data (S809).

If the update data selected by the user is text data (YES in S809), the document set processor 114 requests the operation request transfer unit 112 to display a text data input window (S810). The operation request transfer unit 112 instructs the UI display unit 111 to display the text data input window. The UI display unit 111 displays the text data input window on the display 102. Then, the process shifts to S811.

In S811, the document set processor 114 transfers, to the update processor 115, storage destination information of the image data, or the text data, and the update destination of the image data or text data (S811). The data update destination is indicated by storage location information described in the data acquisition definition file 300 of the document set shown in FIG. 3.

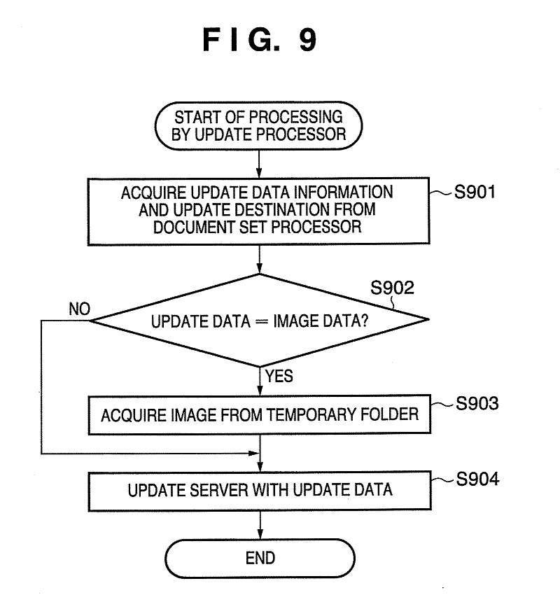

FIG. 9 is a flowchart showing processing by the update processor 115 according to the embodiment.

The update processor 115 acquires, from the document set processor 114, storage location information for the image data, or the text data, and the update destination of the image data or text data (S901).

Then, the update processor 115 determines whether the update data is image data (S902). If data transferred from the document set processor 114 are the storage destination information and update destination of image data, the update processor 115 determines that the update data is image data.

If the update data is image data (YES in S902), the update processor 115 acquires the image data from the temporary folder 116 on the basis of the storage destination information acquired from the document set processor 114 (S903).

If the update data is not image data (NO in S902), the update data is text data. The document set processor 114 has already transferred the text data with update destination as update data information.

In S904, the update processor 115 updates the image data or text data serving as the update data, with the update destination of the server 105 that has been transferred from the document set processor 114. More specifically, the update processor 115 determines an update destination (data storage destination) corresponding to the update data from the data acquisition definition file 300 in FIG. 3, and updates the update data with the determined update destination.

FIG. 9 shows a mechanism of updating the server 105 with either image data or text data. When update data are both image data and text data, the server 105 may be updated with both of them.

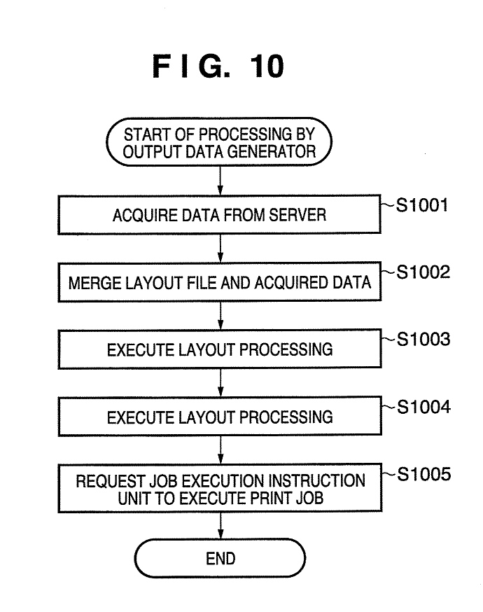

FIG. 10 is a flowchart showing processing by the output data generator 117 according to the embodiment.

The output data generator 117 acquires data from the server 105 (S1001). More specifically, if output data is designated, the output data generator 117 determines, from the data acquisition definition file 300 in FIG. 3, the storage destination of each data item required to generate the output data, and acquires each data item from the determined storage destination.

The output data generator 117 merges a layout file and acquired data (image data and text data) (S1002). Data is acquired from the server 105 on the basis of the update destination of the target data.

The output data generator 117 lays out the merged data (S1003), and executes rendering processing (S1004), thereby generating document data.

Finally, the output data generator 117 requests the job execution unit 106 to execute a print job for the generated document data (S1005).

In the above-described example, the output data generator 117 shifts to processing by the data merge unit 207 after acquiring all data from the server 105. However, the output data generator 117 may request necessary data from the data acquisition unit 206 during merge processing by the data merge unit 207. In this case, every time data is requested, the data acquisition unit 206 acquires necessary data from the server 105.

In addition, the functions shown by each of the blocks of the application execution unit 103, the job execution unit 106, the UI display unit 111, the operation request transfer unit 112, the document set processor 114, the update processor 115, the output data generator 117, and the job execution instruction unit 118 in FIG. 1 are implemented when the CPU of the printing apparatus 101 executes programs in the ROM or HDD of the printing apparatus 101. Also, processes by the above-mentioned blocks shown in the flowcharts of FIGS. 6 to 10 are also implemented when the CPU of the printing apparatus 101 executes programs in the ROM or HDD of the printing apparatus 101. The HDD need not be incorporated into the printing apparatus 101, but may also be arranged outside. Further, the HDD is allowed to perform as the document set DB 113 in FIG. 1 and as the temporary folder 116.

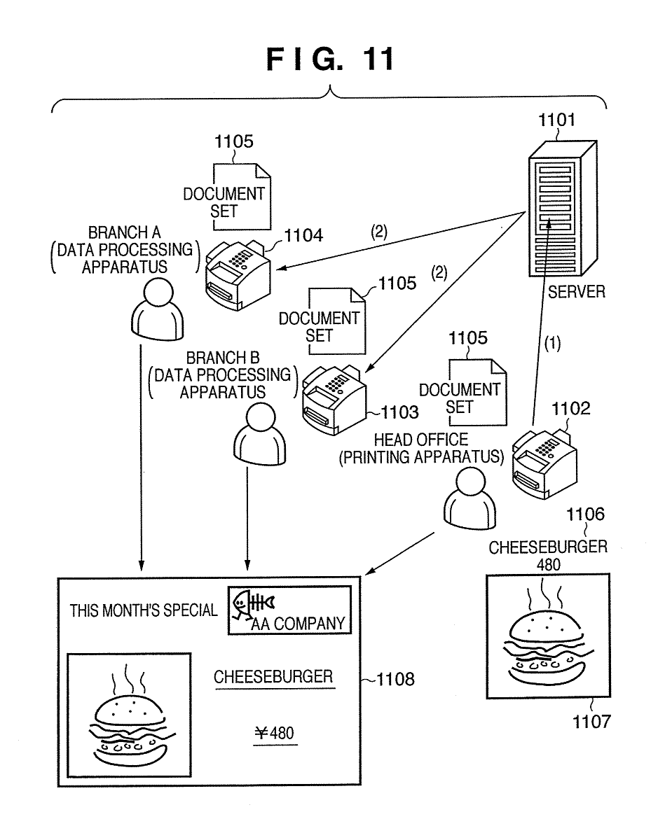

FIG. 11 is a view showing a configuration of a data update processing system using a printing apparatus according to the embodiment.

A printing apparatus 1102, and data processing apparatuses 1103 and 1104 can access a server 1101. The printing apparatus 1102, and data processing apparatuses 1103 and 1104 have identical document sets 1105. Assume that the document set 1105 is the document set shown in FIG. 3.

The printing apparatus 1102 receives text data “480 (cheeseburger)” 1106, scans image data 1107, and updates the server 1101 with them (1).

When the data processing apparatuses 1103 and 1104 generate document data using the document set 1105, document data 1108 is generated using updated data (2), not previously generated document data as shown in FIG. 5. Document data generation processing by the data processing apparatuses 1103 and 1104 is the same as that for acquiring required data from the server and generating document data as performed by the printing apparatus 101, and thus a description thereof will be omitted.

Also when the printing apparatus 1102 generates document data using the document set 1105, the document data 1108 is generated.

As described above, according to the embodiment, the storage destination of data to be updated is managed in the server, and input data is transmitted by designating the storage destination. Hence, data recorded in the server can be updated without any particular need to look up the storage destination of data to be updated.

When the user selects data to be updated on preview image data, the printing apparatus automatically determines the storage destination of the data to be updated from the data acquisition definition file. The embodiment can improve user friendliness.

Furthermore, according to the embodiment, since updated data is stored in the server, it can be shared with a data processing apparatus other than the printing apparatus. Also, while in the above embodiment the storage destination of the data to be updated is overwritten by the update data, the data to be displayed can also be updated by acquiring another storage destination of the data to be updated and updating the data acquisition definition file. Accordingly, it will be easy to restore the updated data to its original data if necessary.

The object of the present invention is also achieved by supplying a storage medium which stores software program codes for implementing the functions of the above-described embodiment to a system or apparatus, reading out the program codes from the storage medium, and executing them using a computer of the system or the like.

In this case, the program codes read out from the storage medium implement the functions of the above-described embodiment. The program codes and the storage medium which stores the program codes constitute the present invention.

The storage medium for supplying the program codes includes a flexible disk, hard disk, optical disk, magneto-optical disk, CD-ROM, CD-R, magnetic tape, nonvolatile memory card, and ROM.

The present invention also includes a case where an OS or the like running on the computer performs some or all of actual processes on the basis of the instructions of the program codes read out by the computer and thereby implements the functions of the above-described embodiment.

Further, the present invention includes a case where the functions of the above-described embodiment are implemented as follows. That is, the program codes read out from the storage medium are written in the memory of, for example, a function expansion unit connected to the computer. Then, the CPU or the like performs some or all of actual processes on the basis of the instructions of the program codes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-296596 filed on Oct. 31, 2006, which is hereby incorporated by reference herein in its entirety.

What is claimed is:

1. A printing apparatus which reads a plurality of data from a server, composes the plurality of data into print data, and prints the print data, the apparatus comprising:
a display unit configured to display a layout of the plurality of data read from the server;
a selection unit configured to select a data area in the layout;
an image input unit configured to input image data by scanning an image; and
a save unit configured to save the image data input by said image input unit in the server in correspondence with the area selected in the layout.

2. The printing apparatus according to claim 1, wherein said save unit saves the image data input by said image input unit in the server in place of the image data which has already been saved in correspondence with the data area selected in the layout.

3. The printing apparatus according to claim 1, further comprising a text input unit configured to input text data, wherein said save unit configured to save the text data input by said text input unit in the server in correspondence with the data area selected in the layout.

4. The printing apparatus according to claim 3, further comprising a determination unit configured to determine whether the data area selected by said selection unit is an image data area or a text data area, and an input request unit configured to request an image data input from said image input unit if the selected data area is determined to be an image data area, and request a text data input from said text data input unit if the selected data area is determined to be a text data area.

5. A data update processing method for a printing apparatus which reads a plurality of data from a server, composes the plurality of data into print data, and prints the print data, the method comprising the steps of:
displaying a layout of the plurality of data read from the server;
selecting a data area in the layout;
image inputting image data by scanning an image; and
saving the image data input in the image inputting step in the server in correspondence with the area selected in the layout.

6. A program stored in storage medium for causing a computer to execute data update processing for a printing apparatus which reads a plurality of data from a server, composes the plurality of data into print data, and prints the print data, the program causing the computer to execute the steps of
displaying a layout of the plurality of data read from the server,
selecting a data area in the layout,
image inputting image data by scanning an image, and
saving the image data input in the image inputting step in the server in correspondence with the area selected in the layout.
